(19) United States
(12) Patent Application Publication
(10) Pub. No.: US 2019/0042355 A1
(43) Pub. Date: Feb. 7, 2019

(54) RAID WRITE REQUEST HANDLING WITHOUT PRIOR STORAGE TO JOURNALING DRIVE

(71) Applicant: Intel Corporation, Santa Clara, CA (US)

(72) Inventors: Slawomir Ptak, Gdansk (PL); Piotr Wysocki, Gdansk (PL); Kapil Karkra, Chandler, AZ (US); Sanjeev N. Trika, Portland, OR (US)

(21) Appl. No.: 16/018,448

(22) Filed: Jun. 26, 2018

(51) Int. Cl. G06F 11/10; G06F 3/06; G06F 11/14; G06F 13/28

(52) U.S. Cl. CPC G06F 11/108; G06F 3/0656; G06F 11/1441; G06F 2212/262; G06F 3/0689; G06F 13/28; G06F 3/0604

(57) ABSTRACT

An apparatus may include a storage driver, the storage driver coupled to a processor, to a non-volatile random access memory (NVRAM), and to a redundant array of independent disks (RAID), the storage driver to: receive a memory write request from the processor for data stored in the NVRAM; calculate parity data from the data and store the parity data in the NVRAM; and write the data and the parity data to the RAID without prior storage of the data and the parity data to a journaling drive. In embodiments, the storage driver may be integrated with the RAID. In embodiments, the storage driver may write the data and the parity data to the RAID by direct memory access (DMA) of the NVRAM.

### FIELD

Embodiments of the present disclosure relate to data storage in redundant arrays of independent disks (RAID), and in particular to RAID write request handling without prior storage to journaling drive.

### BACKGROUND

The RAID Write Hole (RWH) scenario is a computer memory fault scenario, where data sent to be stored in a parity based RAID may not actually be stored if a system failure occurs while the data is “in-flight.” It occurs when both a power-failure or crash and a drive-failure, such as, for example, a strip read or a complete drive crash, occur at the same time or very close to each other. These system crashes and disk failures are often correlated events. When these events occur, it is not certain that the system had sufficient time to actually store the data and associated parity data in the RAID before the failures. Occurrence of a RWH scenario may lead to silent data corruption or irrecoverable data due to a lack of atomicity of write operations across member disks in a parity based RAID. As a result, the parity of an active stripe during a power-failure may be incorrect, due to being, for example, inconsistent with the rest of the strip data. Thus, data on such inconsistent strips may not have the desired protection, and what is worse, may lead to incorrect corrections, known as silent data errors.

### BRIEF DESCRIPTION OF THE DRAWINGS

FIG. 1 depicts an example system, in accordance with various embodiments.

FIG. 2 illustrates an example memory write request flow, in accordance with various embodiments.

FIG. 3 illustrates an overview of the operational flow of a process for persistently storing data prior to writing it to a RAID, in accordance with various embodiments.

FIG. 4 illustrates an overview of the operational flow of a process for recovering data following occurrence of a RAID Write Hole (RWH) condition, in accordance with various embodiments.

FIG. 5 illustrates a block diagram of a computer device suitable for practicing the present disclosure, in accordance with various embodiments.

FIG. 6 illustrates an example computer-readable storage medium having instructions configured to practice aspects of the processes of FIGS. 2-4, in accordance with various embodiments.

### DETAILED DESCRIPTION

In embodiments, an apparatus may include a storage driver, wherein the storage driver is coupled to a processor, to a non-volatile random access memory (NVRAM), and to a redundant array of independent disks (RAID), the storage driver to: receive a memory write request from the processor for data stored in the NVRAM; calculate parity data from the data and store the parity data in the NVRAM; and write the data and the parity data to the RAID without prior storage of the data and the parity data to a journaling drive.

In embodiments, the storage driver may be integrated with the RAID. In embodiments, the storage driver may write the data and the parity data to the RAID by direct memory access (DMA) of the NVRAM.

In embodiments, one or more non-transitory computer-readable storage media may comprise a set of instructions, which, when executed by a storage driver of a plurality of drives configured as a RAID, may cause the storage driver to, in response to a write request from a CPU coupled to the storage driver for data stored in a NVRAM coupled to the storage driver, calculate parity data from the data, store the parity data in the NVRAM, and write the data and the parity data from the NVRAM to the RAID, without prior storage of the data and the parity data to a journaling drive.

In embodiments, a method may be performed by a storage driver of a RAID, of recovering data following occurrence of a RWH condition. In embodiments, the method may include determining that both a power failure of a computer system coupled to the RAID and a failure of a drive of the RAID have occurred. In embodiments, the method may further include, in response to the determination, locating data and associated parity data in a NVRAM coupled to the computer system and to the RAID, and repeating the writes of the data and the associated parity data from the NVRAM to the RAID without first storing the data and the parity data to a journaling drive.

In embodiments, a method of persistently storing data prior to writing it to a RAID may include receiving, by a storage driver of the RAID, a write request from a CPU coupled to the storage driver for data stored in a portion of a NVRAM coupled to the CPU and to the storage driver, calculating parity data from the data, storing the parity data in the NVRAM, and writing the data and the parity data from the NVRAM to the RAID, without prior storage of the data and the parity data to a journaling drive.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), (A) or (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Apparatus, computer readable media and methods according to various embodiments may address the RWH scenario. It is thus here noted that the RWH is a fault scenario, related to parity based RAID.

Existing methods addressing the RWH scenario rely on a journal, where data is stored before being sent to RAID member drives. For example, some hardware RAID cards have a battery backed up DRAM buffer, where all of the data and parity is staged. Other examples, implementing software based solutions, may use either RAID member drives themselves, or a separate journaling drive for this purpose.

It is thus noted that, in such conventional solutions, a copy of data has to be first saved to either non-volatile (or battery backed) storage, for each piece of data written to a RAID volume. This extra step introduces performance overhead via the additional write operation to the drive, as well as additional cost, due to the need for battery backed DRAM at the RAID controller. In addition to the overhead of data copy, there is also a requirement of having the data and parity fully saved in the journal before they can be sent to RAID member drives, which introduces additional delay related to the sequential nature of these operations (lack of concurrency).

Thus, current methods for RWH closure involve writing data and parity data (also known as “journal data”) from RAM to non-volatile or battery backed media before sending this data to RAID member drives. In the case of RWH conditions, a recovery may be performed, which may include reading the journal drive and recalculating parity for the stripes which were targeted with in-flight writes during the power failure. Thus, conventional methods of RWH closure require an additional write to a journaling drive. This additional write request introduces a performance degradation for a write path.

In embodiments, the extra journaling step may be obviated. Therefore, in embodiments, a user application, when allocating memory for data to be transferred to a RAID volume, may allocate it in NVRAM, instead of the more standard volatile RAM. Then, for example, a DMA engine may transfer the data directly from the NVRAM to the RAID member drives. Since NVRAM is by definition persistent, it can be treated as a write buffer, but may not introduce any additional data copy (as the data may be written to a RAM in any event, prior to being written to a storage device). Thus, systems and methods in accordance with various embodiments, may be termed “Zero Data Copy.”

Thus, in embodiments, the RWH problem may be properly planned for, with zero data copy on the host side, up to a point where data may be saved to the RAID member drives. It is here noted that in implementations in accordance with various embodiments, no additional data need be sent to the RAID drives. Such example implementations leverage the fact that every application performing I/O to a storage device (e.g., a RAID array) may need to temporarily store the data in RAM. If, instead of conventional RAM, NVRAM is used, then the initial temporary storage in NVRAM by the application may be used to recover from a RWH condition.

Various embodiments may be applied to any parity based RAID, including, for example, RAID 5, RAID 6, or the like.

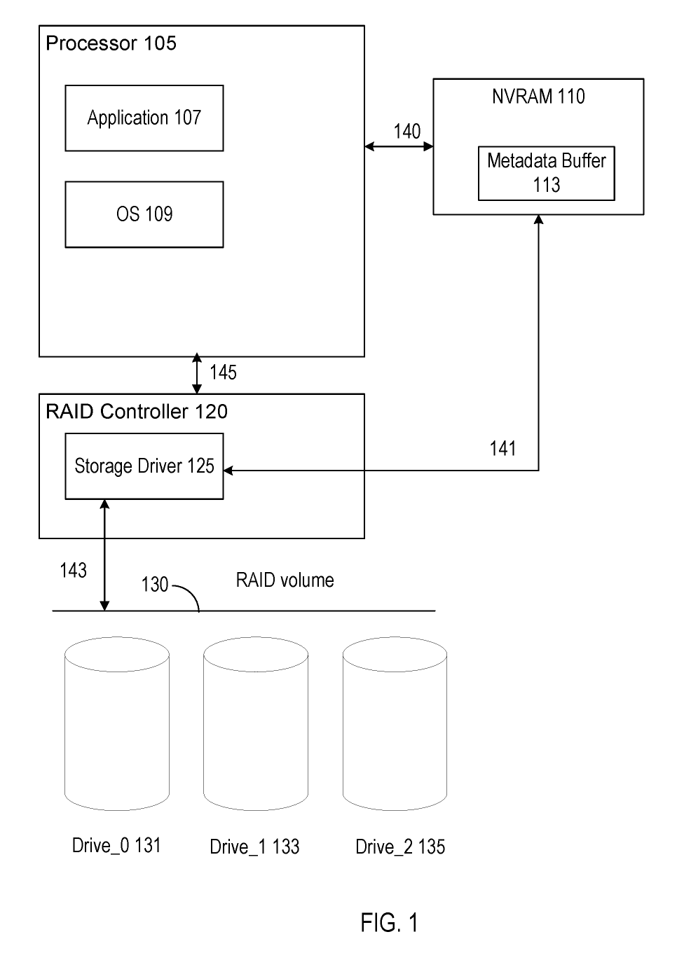

FIG. 1 illustrates an example computing system with a RAID array, in accordance with various embodiments. With reference thereto, the system may include processor 105, which may run application 107. Processor 107 may further be running operating system (OS) 109. Moreover, processor 105 may be coupled to NVRAM 110, which application 107 may utilize for temporary storage of data that it may generate, prior to the data being stored in long term memory, such as RAID volume 130. In particular, application 107 may, as part of its activities, send memory write requests for various data that it may generate, to a filesystem (not shown). The request sent to the filesystem may travel through a storage stack of OS 109. When such a memory write request is sent by it, application 107 may also allocate memory in NVRAM for the data, so that it may be temporarily stored, while waiting for the memory write request to RAID volume 130 to be executed.

Continuing with reference to FIG. 1, NVRAM 110 may further include metadata buffer 113, which may store metadata regarding data that is stored in NVRAM 110, such as, for example, physical addresses within NVRAM of such data.

As shown, NVRAM 110 may be communicatively coupled by link 140 to processor 105, and may also be communicatively coupled to RAID controller 120. RAID controller 120 may be a hardware card, for example, or, for example, it may be a software implementation of control functionality for RAID volume 130. If a software implementation, RAID controller 120 may be implemented as computer code stored on a RAID volume, e.g., on one of the member drives or on multiple drives of RAID volume 130, and run on a system CPU, such as processor 105. The code, in such a software implementation, may alternatively be stored outside of the RAID volume. Additionally, if RAID controller 120 is implemented as hardware, then, in one embodiment, NVRAM 110 may be integrated within RAID controller 120.

It is here noted that a RAID controller, such as RAID controller 120, is a hardware device or a software program used to manage hard disk drives (HDDs) or solid-state drives (SSDs) in a computer or storage array so they work as a logical unit. It is further noted that a RAID controller offers a level of abstraction between an operating system and physical drives. A RAID controller may present groups to applications and operating systems as logical units for which data protection schemes may be defined. Because the controller has the ability to access multiple copies of data on multiple physical devices, it has the ability to improve performance and protect data in the event of a system crash.

In hardware-based RAID, a physical controller may be used to manage the RAID array. The controller can take the form of a PCI or PCI Express (PCIe) card, which is designed to support a specific drive format such as SATA or SCSI. (Some RAID controllers can also be integrated with the motherboard.) A RAID controller may also be software-only, using the hardware resources of the host system. Software-based RAID generally provides similar functionality to hardware-based RAID, but its performance is typically less than that of the hardware versions.

It is here noted that in a case of a software implemented RAID, a DMA engine may be provided in every drive, and each drive may use its DMA engine to transfer a portion of data which belongs to that drive. In a case of a hardware implemented RAID, there may be multiple DMA engines, such as, for example, one in a HW RAID controller, and one in every drive, for example. Such a HW RAID DMA may, in embodiments, thus transfer data from an NVRAM to a HW RAID buffer, and then each drive may use its DMA engine to transfer data from that buffer to the drive.

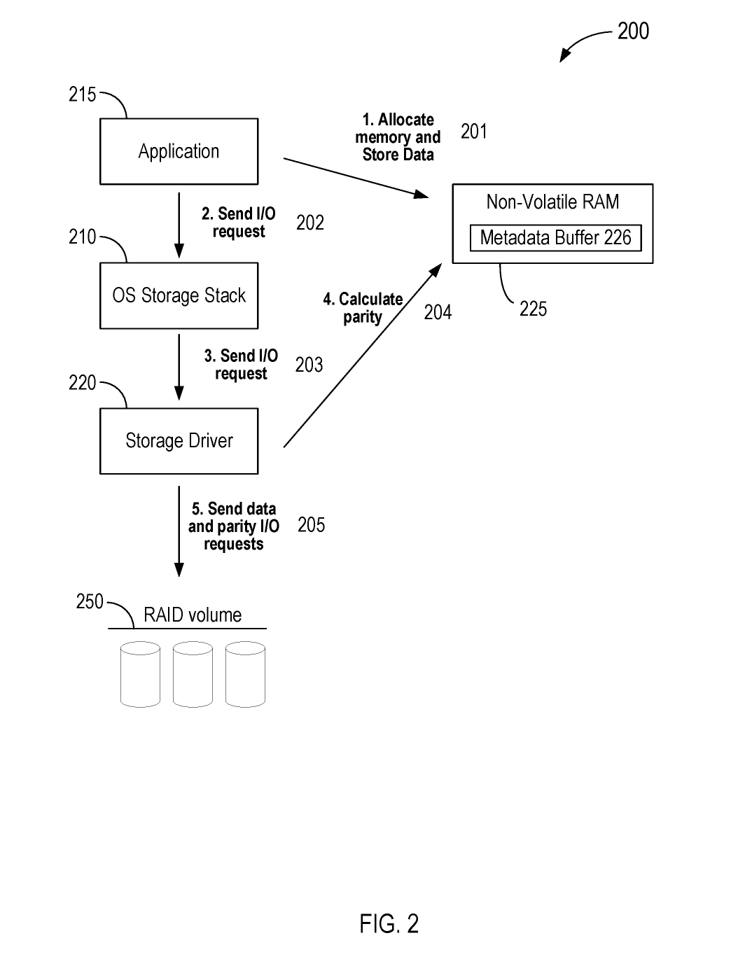

Continuing with reference to FIG. 1, RAID controller 120 may be coupled to processor 105 over link 145, and may further include storage driver 125, which is coupled to and interacts with NVRAM 110, over link 141. Storage driver 125 is thus also coupled to processor 105, through link 145 of RAID controller 120. Accordingly, as shown, storage driver 125 is further coupled to RAID volume 130, which itself may include three drives, for example drive_0 131, drive_1 133 and drive_2 135. It is noted that the three drives are shown for purposes of illustration, and, in embodiments, RAID volume 130 may include any greater or smaller number of drives, depending on implementation requirements or use case. In embodiments, as described in detail with reference to FIG. 2, storage driver 125 controls drives 0 131, 1 133 and 2 135, calculates parity based on the stored data in NVRAM 110, and stores the parity for that data in NVRAM 110 as well. Moreover, in embodiments, in addition to actual parity data, storage driver 125 may also need to store data and parity metadata information, such as target logical block addresses (LBA), within NVRAM 110, which may be necessary in the event of a RWH recovery. This metadata may be stored in metadata buffer 113 of NVRAM 110, for example. After storing both parity data and parity data metadata, storage driver 125 may also submit a data and parity write request to member drives of RAID volume 130.

FIG. 2, next described, illustrates an example write request flow in accordance with various embodiments. The example flow is divided into five tasks, 201-205. Here, as noted above, because data stored in NVRAM 225 is already persistent, there is no need for an additional I/O request to a journaling drive. In embodiments, with reference to FIG. 2, in a first task 201, application 215 may first allocate a piece of memory to store some data that it intends to send to RAID volume 250. This allocation 201 may be performed on NVRAM 225, as shown. In embodiments, there are several methods that may be used to achieve the allocation in NVRAM. First, for example, application 215 may be modified, so that instead of using a standard malloc function to allocate memory in regular RAM, it may specifically allocate a portion of NVRAM 225 to store the data. Alternatively, for example, a C standard library used or called by application 215 may be substituted with a variant version that includes modified ‘malloc’ and ‘free’ functions (it is noted that in a standard C library there may generally be two main functions used to manage memory, ‘malloc’ and “free’). Still alternatively, a computing platform whose entire memory is NVRAM may be used. Thus, even if a standard C library malloc function is called, for example, the application will still allocate memory in what is the available RAM, namely NVRAM 225.

Continuing with reference to FIG. 2, in a second task 202, application 215 sends an I/O (write) request to a filesystem (not shown). It is here noted that, in order to achieve a full “zero data copy” principle, in embodiments such a filesystem may not use a page cache, but rather may send write requests using a direct I/O flag. The I/O request then travels through OS storage stack 210, maintained by an operating system running on the computing platform that application 215 may interact with as it runs.

In a third task, OS storage stack 210 may send the write request to storage driver 220. Storage driver may be aware of data layout on RAID member drives of RAID volume 250, which storage driver 220 may control. Continuing with reference to FIG. 2, in a fourth task, storage driver 220, in response to receipt of the I/O request, may calculate parity based on the stored data in NVRAM 225, and store the parity for that data in NVRAM 225 as well. As noted above, parity, along with the data, may be required for RWH recovery. Moreover, in embodiments, in addition to the actual parity data, storage driver 220 may also need to store data and parity metadata information, such as target logical block addresses (LBA) within NVRAM 225, which may be necessary in the event of a RWH recovery. This metadata may be stored in metadata buffer 226 of NVRAM 225. Thus, because at this point all of the information required for RWH recovery is already stored in non-volatile memory, in a final task 205, storage driver 220 may submit a data and parity write request to member drives of RAID volume 250. Accordingly, a task of storing of the data and the parity data to a journaling drive that may occur in conventional solutions, may not be required in accordance with the embodiments of the present disclosure, which leverage temporary storage of data to be written to the RAID in NVRAM.

In embodiments, given the write request flow of FIG. 2 being fully accomplished, an example system is ready to perform a recovery of data and parity data in the event of a RWH occurrence. Thus, in embodiments, assuming such a scenario, RWH recovery flow may be as follows. After the RWH conditions have occurred, namely power failure and RAID member drive failure, it is assumed that the computing platform has rebooted. Thus, in embodiments, a UEFI or OS driver of the RAID engine may be loaded. It is here noted that “storage driver” is a generic term which may, for example, apply to either a UEFI driver or to an OS driver. The driver may then discover that RWH conditions have occurred, and may locate RAID journal metadata in NVRAM, such as, for example, NVRAM 225. As noted above, this may, in embodiments, include reading the metadata in metadata buffer 226, to locate the actual data and parity data in NVRAM 225, for the requests that were in-flight during the power failure. In embodiments, the driver may then replay the writes of data and parity, making the parity consistent with the data and fixing the RWH condition.

It is here noted that the data and the parity data (sometimes referred to herein as “RWH journal data”, given that historically it was first written to a separate journaling drive, in an extra write step), may needed to be maintained for in-flight data. Therefore, in embodiments, once data has been written to the RAID drives, the journal may be deleted. As a result of this fact, in embodiments, the capacity requirements for NVRAM are relatively small. For example, based on a maximum queue depth supported by a RAID 5 volume, consisting of 48 NVMe drives, the required size of NVRAM is equal to about 25 MB. Thus, in embodiments, an NVRAM module which is already in a given system, and used for some other purposes, may be leveraged for RWH journal data use. Thus, to implement various embodiments no dedicated DIMM module may be required.

It is noted that, in embodiments, a significant performance advantage may be realized when NVRAM devices become significantly faster relative to regular solid state device (SSD) drives (i.e., NVRAM speed comparable to DRAM performance). In such cases, the disclosed solution may perform significantly better compared to current solutions, and performance may expected to be close to that where no RAID Write Hole protection is offered.

It may also be possible, that applications may make persistent RAM allocations for reasons other than RWH closure, such as, for example, caching in NVRAM. In such cases, the fact that those allocations are persistent may be leveraged, in accordance with various embodiments.

As noted above, during recovery, an example storage driver may need to know the physical location of the data it seeks in the NVRAM. In order to achieve this, in embodiments, the storage driver preferably may store the physical addresses of data and parity data in some predefined and hardcoded location. In embodiments, a pre-allocated portion of NVRAM may thus be used, such as Metadata Buffer 226 of FIG. 2, that is dedicated for this purpose and hidden from the OS (so as not to be overwritten or otherwise used). In embodiments, this memory (buffer) may contain metadata that points to physical locations of the needed data in NVRAM.

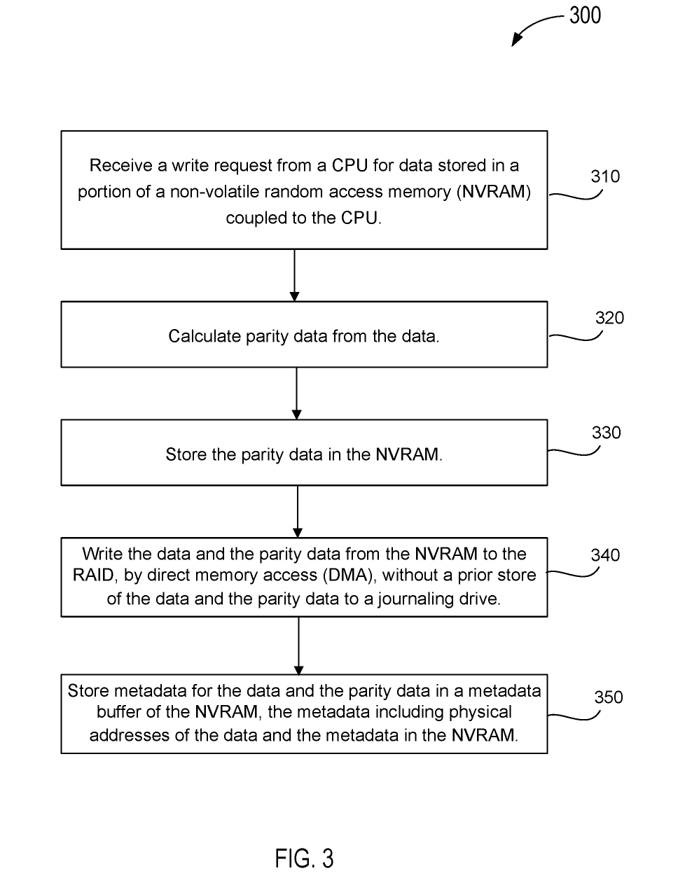

Referring now to FIG. 3, an overview of the operational flow of a process for persistently storing data prior to writing it to a redundant array of independent disks (RAID), in accordance with various embodiments, is presented. Process 300 may be performed by apparatus such as storage driver 125 as shown in FIG. 1, or, for example, Storage Driver 220, as shown in FIG. 2, according to various embodiments.

Process 300 may include blocks 310 through 350. In alternate embodiments, process 300 may have more or less operations, and some of the operations may be performed in different order.

Process 300 may begin at block 310, where an example apparatus may receive, a write request to a RAID from a CPU for data stored in a portion of a non-volatile random access memory (NVRAM) coupled to the CPU. As noted, the apparatus may be Storage driver 125, itself provided in RAID Controller 120, the RAID which is the destination identified in the write request may be RAID volume 130, and the CPU may be Processor 105, both of FIG. 1, where processor 105 is coupled to NVRAM 110, all as shown in FIG. 1.

From block 310, process 300 may proceed to block 320, where the example device may calculate parity data for the data stored in the NVRAM. From block 320, process 300 may proceed to block 330, where the example apparatus may store the parity data which it calculated in block 320 in the NVRAM. At this point, both the data which is the subject of the memory write request, and the parity data calculated from it in block 320, are now stored in persistent memory. Thus, a “back up” of this data now exists, in case there is a RWH occurrence that prevents the data and associated parity data, once “in-flight” from ultimately being written to the RAID.

From block 330, process 300 may proceed to block 340, where the example apparatus may write the data and the parity data from the NVRAM to the RAID, without a prior store of the data and the parity data to a journaling drive. For example, this transfer may be made by direct memory access (DMA), using a direct link between the example apparatus, the NVRAM and the RAID.

As noted above, in the event of a RWH occurrence, an example storage driver may need to locate in the NVRAM the data and associated parity data that was “in-flight” at the time of the RWH occurrence. To facilitate locating this data, the NVRAM may further include a metadata buffer, such as Metadata buffer 113 of FIG. 1. The metadata may include the physical locations in the NVRAM of data which was the subject of a processor I/O request, and its associated parity data. After writing the data and parity data to the NVRAM, as in block 340, process 300 may proceed to block 350, where the example apparatus may store metadata for the data and the parity data in a metadata buffer of the NVRAM. The metadata may include physical addresses of the data and the metadata in the NVRAM.

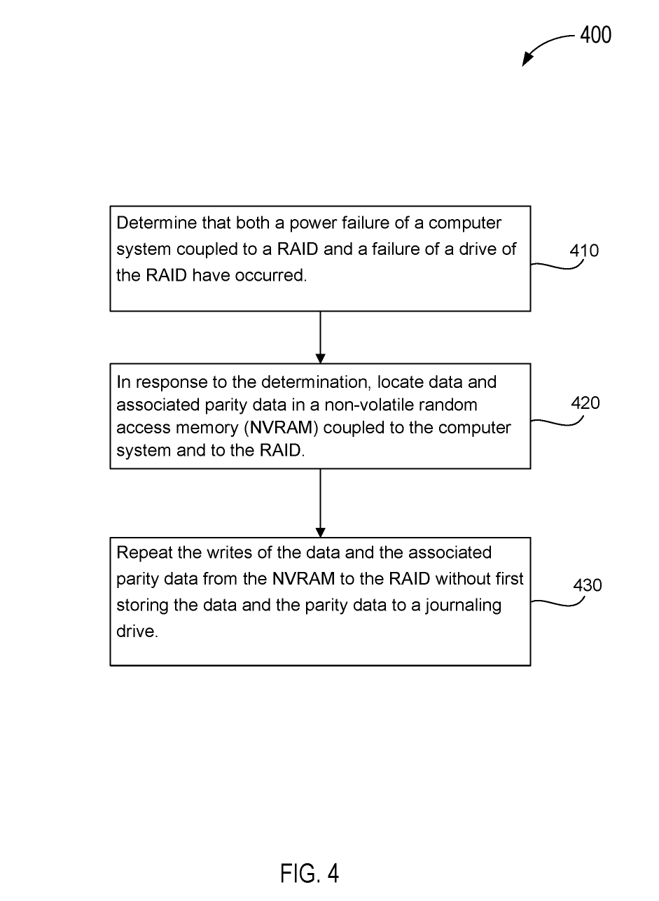

Referring now to FIG. 4, an overview of the operational flow of a process for recovering data following occurrence of a RAID Write Hole (RWH) condition, in accordance with various embodiments, is presented. Process 400 may be performed by apparatus such as Storage driver 125 as shown in FIG. 1, or, for example, Storage Driver 220, as shown in FIG. 2, according to various embodiments. Process 400 may include blocks 410 through 430. In alternate embodiments, process 400 may have more or less operations, and some of the operations may be performed in different order.

Process 400 may begin at block 410, where an example apparatus may determine that both a power failure of a computer system, for example, one including Processor 105 of FIG. 1, coupled to a RAID and a failure of a drive of the RAID have occurred. The RAID may be, for example, RAID volume 130 of FIG. 1. As noted above, in embodiments, after a reboot of a RAID, a Unified Extensible Firmware Interface (UEFI) or operating system (OS) driver of the RAID may be loaded, which will detect that the RWH condition has occurred. It is here noted that a UEFI is a specification for a software program that connects a computer's firmware to its OS. In the case of process 400, the UEFI, or OS driver, may run on a controller of the RAID.

From block 410, process 400 may proceed to block 420, where, in response to the determination, the example apparatus may locate data and associated parity data in a non-volatile random access memory coupled to the computer. In embodiments, as noted above, in so doing the example apparatus may first access a metadata buffer in the NVRAM, such as, for example, Metadata Buffer 113 of FIG. 1. The metadata in the metadata buffer may contain the physical addresses for data and parity data that was stored in the NVRAM, such as by a process such as process 300, as described above. In embodiments, data and parity data for which memory write requests had been already executed by a storage driver to completion, e.g., written to the RAID, may generally be deleted from the NVRAM. Thus, in embodiments, the data and parity data still found in the NVRAM may be assumed to not yet have been written to the RAID. Such data and parity data are known, as noted above, as “in-flight” data.

It is here noted that if the RWH failure condition occurs just as the Storage Driver is about to delete data and parity data from the NVRAM after actually writing it to the RAID, in embodiments this data and parity data, although actually already written out to the RAID, will in block 420 be rewritten to the RAID, there being no drawback to re-writing it.

From block 420, process 400 may proceed to block 430, where the example apparatus may repeat the writes of the data and the associated parity data from the NVRAM to the RAID, thereby curing the “in flight” data problem created by the RWH condition. In embodiments, in similar fashion to the initial write to RAID of the data and parity data, the second rewrite of this data also occurs without first storing the data to a journaling drive, precisely because the initial storage of the data and parity data, according to various embodiments, in NVRAM, being persistent memory, obviates the need for any other form of backup.

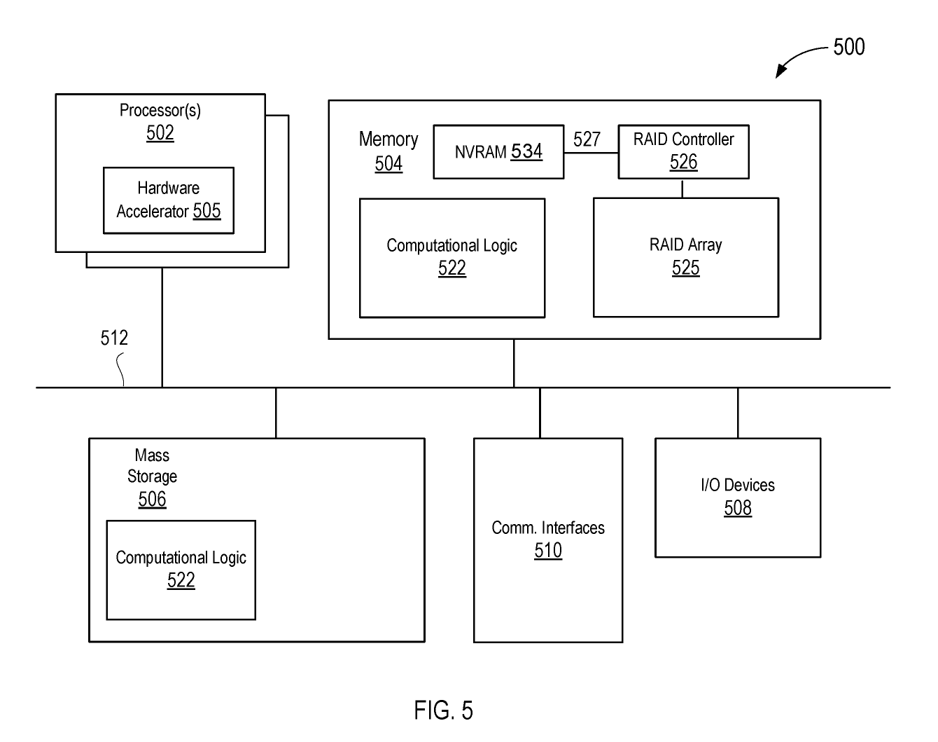

Referring now to FIG. 5 wherein a block diagram of a computer device suitable for practicing the present disclosure, in accordance with various embodiments, is illustrated. As shown, computer device 500 may include one or more processors 502, memory controller 503, and system memory 504. Each processor 502 may include one or more processor cores, and hardware accelerator 505. An example of hardware accelerator 505 may include, but is not limited to, programmed field programmable gate arrays (FPGA). In embodiments, processor 502 may also include a memory controller (not shown). In embodiments, system memory 504 may include any known volatile or non-volatile memory, including, for example, RAID array 525 and RAID controller 526. Thus, system memory 504 may include NVRAM 534, in addition to, or in place of other types of RAM, such as dynamic random access memory (DRAM) (not shown), as described above. RAID controller 526 may be directly connected to NVRAM 534, allowing it to perform memory writes of data stored in NVRAM 534 to RAID array 525 by direct memory access (DMA), via link or dedicated bus 527.

Additionally, computer device 500 may include mass storage device(s) 506 (such as solid state drives), input/output device interface 508 (to interface with various input/output devices, such as, mouse, cursor control, display device (including touch sensitive screen), and so forth) and communication interfaces 510 (such as network interface cards, modems and so forth). In embodiments, communication interfaces 510 may support wired or wireless communication, including near field communication. The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage device(s) 506 may be employed to store a working copy and a permanent copy of the executable code of the programming instructions of an operating system, one or more applications, and/or various software implemented components of storage driver 125, RAID controller 120, both of FIG. 1, or storage driver 220, application 215, or storage stack 210, of FIG. 2, collectively referred to as computational logic 522. The programming instructions implementing computational logic 522 may comprise assembler instructions supported by processor(s) 502 or high-level languages, such as, for example, C, that can be compiled into such instructions. In embodiments, some of computing logic may be implemented in hardware accelerator 505. In embodiments, part of computational logic 522, e.g., a portion of the computational logic 522 associated with the runtime environment of the compiler may be implemented in hardware accelerator 505.

The permanent copy of the executable code of the programming instructions or the bit streams for configuring hardware accelerator 505 may be placed into permanent mass storage device(s) 506 and/or hardware accelerator 505 in the factory, or in the field, through, for example, a distribution medium (not shown), such as a compact disc (CD), or through communication interface 510 (from a distribution server (not shown)). While for ease of understanding, the compiler and the hardware accelerator that executes the generated code that incorporate the predicate computation teaching of the present disclosure to increase the pipelining and/or parallel execution of nested loops are shown as being located on the same computing device, in alternate embodiments, the compiler and the hardware accelerator may be located on different computing devices.

The number, capability and/or capacity of these elements 510-512 may vary, depending on the intended use of example computer device 500, e.g., whether example computer device 500 is a smartphone, tablet, ultrabook, a laptop, a server, a set-top box, a game console, a camera, and so forth. The constitutions of these elements 510-512 are otherwise known, and accordingly will not be further described.

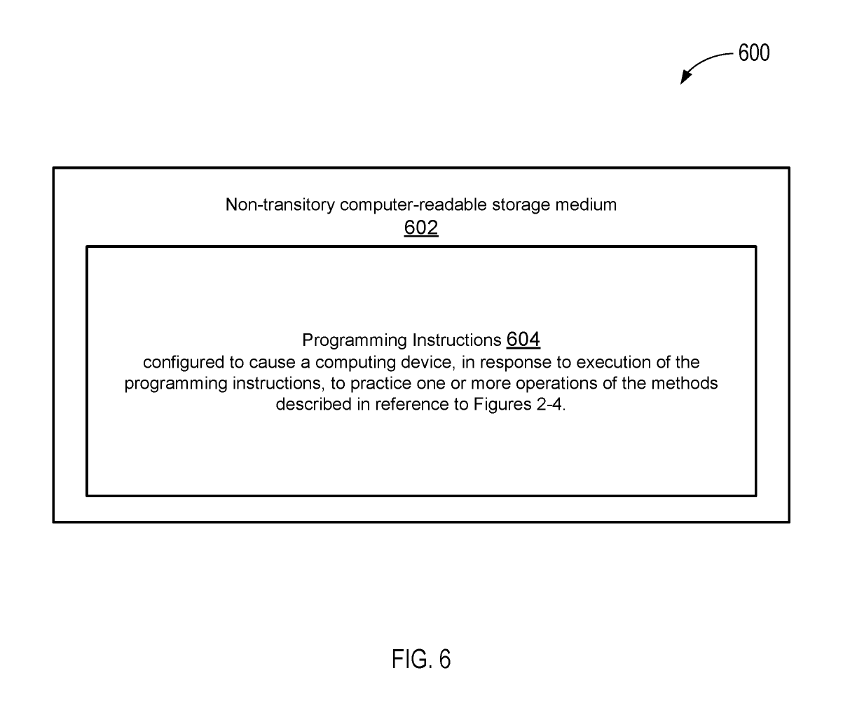

FIG. 6 illustrates an example computer-readable storage medium having instructions configured to implement all (or portion of) software implementations of storage driver 125, RAID controller 120, both of FIG. 1, or storage driver 220, application 215, or storage stack 210, of FIG. 2, and/or practice (aspects of) processes 200 of FIG. 2, 300 of FIG. 3 and 400 of FIG. 4, earlier described, in accordance with various embodiments. As illustrated, computer-readable storage medium 602 may include the executable code of a number of programming instructions or bit streams 604. Executable code of programming instructions (or bit streams) 604 may be configured to enable a device, e.g., computer device 500, in response to execution of the executable code/programming instructions (or operation of an encoded hardware accelerator 575), to perform (aspects of) process 200 of FIG. 2, 300 of FIG. 3 and 400 of FIG. 4. In alternate embodiments, executable code/programming instructions/bit streams 704 may be disposed on multiple non-transitory computer-readable storage medium 602 instead. In embodiments, computer-readable storage medium 602 may be non-transitory. In still other embodiments, executable code/programming instructions 604 may be encoded in transitory computer readable medium, such as signals.

Referring back to FIG. 5, for one embodiment, at least one of processors 502 may be packaged together with a computer-readable storage medium having some or all of computing logic 522 (in lieu of storing in system memory 504 and/or mass storage device 506) configured to practice all or selected ones of the operations earlier described with reference to FIGS. 2-4. For one embodiment, at least one of processors 502 may be packaged together with a computer-readable storage medium having some or all of computing logic 522 to form a System in Package (SiP). For one embodiment, at least one of processors 502 may be integrated on the same die with a computer-readable storage medium having some or all of computing logic 522. For one embodiment, at least one of processors 502 may be packaged together with a computer-readable storage medium having some or all of computing logic 522 to form a System on Chip (SoC). For at least one embodiment, the SoC may be utilized in, e.g., but not limited to, a hybrid computing tablet/laptop.

It is noted that RAID write journaling methods according to various embodiments may be implemented in, for example, the Intel™ software RAID product (VROC), or, for example, may utilize Crystal Ridge™ NVRAM.

Illustrative examples of the technologies disclosed herein are provided below. An embodiment of the technologies may include any one or more, and any combination of, the examples described below.

### Examples

Example 1 is an apparatus comprising a storage driver coupled to a processor, a non-volatile memory (NVRAM), and a redundant array of independent disks (RAID), to: receive a memory write request from the processor for data stored in the NVRAM; calculate parity data from the data and store the parity data in the NVRAM; and write the data and the parity data to the RAID without prior storage of the data and the parity data to a journaling drive.

Example 2 may include the apparatus of example 1, and/or other example herein, wherein the storage driver is integrated with the RAID.

Example 3 may include the apparatus of example 1, and/or other example herein, wherein the journaling drive is either separate from the RAID or integrated with the RAID.

Example 4 may include the apparatus of example 1, and/or other example herein, wherein an operating system running on the processor allocates memory in the NVRAM for the data in response to an execution by the processor of a memory write instruction of a user application and a call to a memory allocation function associated with the operating system.

Example 5 may include the apparatus of example 4, and/or other example herein, wherein the memory allocation function is modified to allocate memory in NVRAM.

Example 6 may include the apparatus of example 4, and/or other example herein, wherein the NVRAM comprises a random access memory associated with the processor, wherein the memory allocation function is to allocate memory for the data in the random access memory.

Example 7 is the apparatus of example 1, and/or other example herein, further comprising the NVRAM, wherein the data is stored in the NVRAM by the processor, prior to sending the memory write request to the storage driver.

Example 8 may include the apparatus of example 7, and/or other example herein, wherein the storage driver writes the data and the parity data to the RAID by direct memory access (DMA) of the NVRAM.

Example 9 may include the apparatus of example 7, and/or other example herein, wherein the NVRAM further includes a metadata buffer, and wherein the storage driver is further to store metadata for the data and the parity data in the metadata buffer, wherein the metadata for the data and the parity data includes the physical addresses of the data and metadata in the NVRAM.

Example 10 may include the apparatus of example 1, and/or other example herein, the storage driver further to delete the data and the parity data from the NVRAM once the data and the parity data are written to the RAID.

Example 11 includes one or more non-transitory computer-readable storage media comprising a set of instructions, which, when executed by a storage driver of a plurality of drives configured as a redundant array of independent disks (RAID), cause the storage driver to: in response to a write request from a CPU coupled to the storage driver for data stored in a non-volatile random access memory (NVRAM) coupled to the storage driver: calculate parity data from the data; store the parity data in the NVRAM; and write the data and the parity data from the NVRAM to the RAID, without prior storage of the data and the parity data to a journaling drive.

Example 12 may include the one or more non-transitory computer-readable storage media of example 11, and/or other example herein, wherein the data is stored in the NVRAM by the CPU, prior to sending the memory write request to the storage driver.

Example 13 may include the one or more non-transitory computer-readable storage media of example 12, and/or other example herein, wherein memory in the NVRAM is allocated by an operating system running on the CPU in response to an execution by the CPU of a memory write instruction of an application.

Example 14 may include the one or more non-transitory computer-readable storage media of example 11, and/or other example herein, further comprising instructions that in response to being executed cause the storage driver to write the data and the parity data to the RAID by direct memory access (DMA) of the NVRAM.

Example 15 may include the one or more non-transitory computer-readable storage media of example 14, and/or other example herein, wherein the NVRAM further includes a metadata buffer, and further comprising instructions that in response to being executed cause the storage driver to store metadata for the data and the parity data in the metadata buffer.

Example 16 may include the one or more non-transitory computer-readable storage media of example 15, and/or other example herein, wherein the metadata includes the physical addresses of the data and the parity data in the NVRAM.

Example 17 may include the one or more non-transitory computer-readable storage media of example 11, and/or other example herein, further comprising instructions that in response to being executed cause the storage driver to: determine that the data and the parity data are written to the RAID; and in response to the determination: delete the data and the parity data from the NVRAM, and delete the metadata from the metadata buffer.

Example 18 may include a method, performed by a storage driver of a redundant array of independent disks (RAID), of recovering data following occurrence of a RAID Write Hole (RWH) condition, comprising: determining that both a power failure of a computer system coupled to the RAID and a failure of a drive of the RAID have occurred; in response to the determination, locating data and associated parity data in a non-volatile random access memory (NVRAM) coupled to the computer system and to the RAID; repeating the writes of the data and the associated parity data from the NVRAM to the RAID without first storing the data and the parity data to a journaling drive.

Example 19 may include the method of example 18, and/or other example herein, wherein repeating the writes further comprises writing the data and the parity data to the RAID by direct memory access (DMA) of the NVRAM.

Example 20 may include the method of example 18, and/or other example herein, wherein locating data and associated parity data further comprises first reading a metadata buffer of the NVRAM, to obtain physical addresses in the NVRAM of the data and parity data that was in-flight during the RWH condition.

Example 21 may include the method of example 18, and/or other example herein, further comprising: determining that the data and the parity data were rewritten to the RAID; and in response to the determination: deleting the data and the parity data from the NVRAM, and deleting the metadata from the metadata buffer.

Example 22 may include a method of persistently storing data prior to writing it to a redundant array of independent disks (RAID), comprising: receiving, by a storage driver of the RAID, a write request from a CPU coupled to the storage driver for data stored in a portion of a non-volatile random access memory (NVRAM) coupled to the CPU and to the storage driver calculating parity data from the data; storing the parity data in the NVRAM; and writing the data and the parity data from the NVRAM to the RAID, without prior storage of the data and the parity data to a journaling drive.

Example 23 may include the method of example 22, and/or other example herein, wherein the NVRAM further includes a metadata buffer, and further comprising storing metadata for the data and the parity data in the metadata buffer, the metadata including physical addresses of the data and the metadata in the NVRAM.

Example 24 may include the method of example 22, and/or other example herein, further comprising: determining that the data and the parity data were written to the RAID; and, in response to the determination: deleting the data and the parity data from the NVRAM, and deleting the metadata from the metadata buffer.

Example 25 may include the method of example 22, and/or other example herein, further comprising writing the data and the parity data to the RAID by direct memory access (DMA) of the NVRAM.

Example 26 may include an apparatus for computing comprising: non-volatile random access storage (NVRAS) means coupled to a means for processing, and storage driver means coupled to each of the processing means, the NVRAS means and a redundant array of independent disks (RAID), the apparatus for computing to: receive a memory write request from the processing means for data stored in the NVRAS means; calculate parity data from the data and store the parity data in the NVRAS means; and write the data and the parity data to the RAID without prior storage of the data and the parity data to a journaling means.

Example 27 may include the apparatus for computing of example 26, and/or other example herein, wherein the storage driver means is integrated with the RAID.

Example 28 may include the apparatus for computing of example 26, and/or other example herein, wherein the journaling means is either separate from the RAID or integrated with the RAID.

Example 29 may include the apparatus for computing of example 26, and/or other example herein, wherein an operating system running on the processing means allocates storage in the NVRAS means for the data in response to an execution by the processing means of a memory write instruction of a user application and a call to a memory allocation function associated with the operating system.

Example 30 may include the apparatus for computing of example 29, and/or other example herein, wherein the memory allocation function is modified to allocate memory in NVRAS means.

Example 31 may include the apparatus for computing of example 26, and/or other example herein, wherein the data is stored in the NVRAS means by the processing means, prior to sending the memory write request to the storage driver means.

Example 32 may include the apparatus for computing of example 26, and/or other example herein, wherein the storage driver means writes the data and the parity data to the RAID by direct memory access (DMA) of the NVRAS means.

Example 33 may include the apparatus for computing of example 26, and/or other example herein, wherein the NVRAS means further includes a metadata buffering means, and wherein the storage driver means is further to store metadata for the data and the parity data in the metadata buffering means, wherein the metadata for the data and the parity data includes the physical addresses of the data and metadata in the NVRAS means.

Example 34 may include the apparatus for computing of example 26, and/or other example herein, the storage driver means further to delete the data and the parity data from the NVRAS means once the data and the parity data are written to the RAID.

What is claimed is:

1. An apparatus, comprising:
a storage driver, wherein the storage driver is coupled to a processor, to a non-volatile random access memory (NVRAM), and to a redundant array of independent disks (RAID), the storage driver to:
receive a memory write request from the processor for data stored in the NVRAM;
calculate parity data from the data and store the parity data in the NVRAM; and
write the data and the parity data to the RAID without prior storage of the data and the parity data to a journaling drive.

2. The apparatus of claim 1, wherein the storage driver is integrated with the RAID.

3. The apparatus of claim 1, wherein the journaling drive is either separate from the RAID or integrated with the RAID.

4. The apparatus of claim 1, wherein the processor is coupled to the NVRAM, and an operating system running on the processor allocates memory in the NVRAM for the data in response to an execution by the processor of a memory write instruction of a user application and a call to a memory allocation function associated with the operating system.

5. The apparatus of claim 4, wherein the memory allocation function is modified to allocate memory in NVRAM.

6. The apparatus of claim 4, wherein the NVRAM comprises a random access memory (RAM) associated with the processor, and wherein the memory allocation function is to allocate memory for the data in the RAM.

7. The apparatus of claim 1, further comprising the NVRAM, wherein the data is stored in the NVRAM by the processor, prior to sending the memory write request to the storage driver.

8. The apparatus of claim 7, wherein the storage driver writes the data and the parity data to the RAID by direct memory access (DMA) of the NVRAM.

9. The apparatus of claim 7, wherein the NVRAM further includes a metadata buffer, and wherein the storage driver is further to store metadata for the data and the parity data in the metadata buffer, wherein the metadata for the data and the parity data includes the physical addresses of the data and metadata in the NVRAM.

10. The apparatus of claim 1, the storage driver further to delete the data and the parity data from the NVRAM once the data and the parity data are written to the RAID.

11. One or more non-transitory computer-readable storage media comprising a set of instructions, which, when executed by a storage driver of a plurality of drives configured as a redundant array of independent disks (RAID), cause the storage driver to:
in response to a write request from a CPU coupled to the storage driver for data stored in a non-volatile random access memory (NVRAM) coupled to the storage driver:
calculate parity data from the data;
store the parity data in the NVRAM; and
write the data and the parity data from the NVRAM to the RAID, without prior storage of the data and the parity data to a journaling drive.

12. The one or more non-transitory computer-readable storage media of claim 11, wherein the data is stored in the NVRAM by the CPU, prior to sending the memory write request to the storage driver.

13. The one or more non-transitory computer-readable storage media of claim 12, wherein memory in the NVRAM is allocated by an operating system running on the CPU in response to an execution by the CPU of a memory write instruction of an application.

14. The one or more non-transitory computer-readable storage media of claim 11, further comprising instructions that in response to being executed cause the storage driver to write the data and the parity data to the RAID by direct memory access (DMA) of the NVRAM.

15. The one or more non-transitory computer-readable storage media of claim 14, wherein the NVRAM further includes a metadata buffer, and further comprising instructions that in response to being executed cause the storage driver to store metadata for the data and the parity data in the metadata buffer.

16. The one or more non-transitory computer-readable storage media of claim 15, wherein the metadata includes the physical addresses of the data and the parity data in the NVRAM.

17. The one or more non-transitory computer-readable storage media of claim 11, further comprising instructions that in response to being executed cause the storage driver to:
determine that the data and the parity data are written to the RAID; and
in response to the determination:
delete the data and the parity data from the NVRAM, and
delete the metadata from the metadata buffer.

18. A method, performed by a storage driver of a redundant array of independent disks (RAID), of recovering data following occurrence of a RAID Write Hole (RWH) condition, comprising:
determining that both a power failure of a computer system coupled to the RAID and a failure of a drive of the RAID have occurred;
in response to the determination, locating data and associated parity data in a non-volatile random access memory (NVRAM) coupled to the computer system and to the RAID;
repeating the writes of the data and the associated parity data from the NVRAM to the RAID without first storing the data and the parity data to a journaling drive.

19. The method of claim 18, wherein repeating the writes further comprises writing the data and the parity data to the RAID by direct memory access (DMA) of the NVRAM.

20. The method of claim 18, wherein locating data and associated parity data further comprises first reading a metadata buffer of the NVRAM, to obtain physical addresses in the NVRAM of the data and parity data that was in-flight during the RWH condition.

21. The method of claim 18, further comprising:
determining that the data and the parity data were rewritten to the RAID; and
in response to the determination:
deleting the data and the parity data from the NVRAM, and
deleting the metadata from the metadata buffer.

22. A method of persistently storing data prior to writing it to a redundant array of independent disks (RAID), comprising:
receiving, by a storage driver of the RAID, a write request from a CPU coupled to the storage driver for data stored in a portion of a non-volatile random access memory (NVRAM) coupled to the CPU and to the storage driver;
calculating parity data from the data;
storing the parity data in the NVRAM; and
writing the data and the parity data from the NVRAM to the RAID, without prior storage of the data and the parity data to a journaling drive.

23. The method of claim 22, wherein the NVRAM further includes a metadata buffer, and further comprising storing metadata for the data and the parity data in the metadata buffer, the metadata including physical addresses of the data and the metadata in the NVRAM.

24. The method of claim 22, further comprising:
determining that the data and the parity data were written to the RAID;
and, in response to the determination:
deleting the data and the parity data from the NVRAM, and
deleting the metadata from the metadata buffer.

25. The method of claim 22, further comprising writing the data and the parity data to the RAID by direct memory access (DMA) of the NVRAM.
